(19) United States
(12) Patent Application Publication
(10) Pub. No.: US 2026/0249280 A1
(43) Pub. Date: Aug. 27, 2026

(54) CATALYST FOR BAEYER-VILLIGER OXIDATION REACTION COMPRISING HIERARCHICALLY NANOPOROUS ZEOLITE AND METHOD OF PREPARING THE SAME

(71) Applicant: KOREA GAS TECHNOLOGY CORPORATION, Daejeon (KR)

(72) Inventors: Kyungduk KIM, Daejeon (KR); Jongil HAN, Daejeon (KR); Seongsu PARK, Daejeon (KR); Injae KIM, Daejeon (KR)

(21) Appl. No.: 19/277,208

(22) Filed: Jul. 22, 2025

(30) Foreign Application Priority Data
Feb. 25, 2025 (KR) 10-2025-0024551

(51) Int. Cl. B01J 29/86; B01J 23/14; B01J 35/30; B01J 35/45; B01J 35/61; B01J 35/63; B01J 35/64; B01J 37/02; B01J 37/08; C01B 37/00

(52) U.S. Cl. CPC B01J 29/86; B01J 23/14; B01J 35/393; B01J 35/45; B01J 35/615; B01J 35/617; B01J 35/633; B01J 35/635; B01J 35/643; B01J 35/647; B01J 37/0215; B01J 37/086; C01B 37/007; B01J 2229/183; B01J 2229/26

(57) ABSTRACT

A catalyst for a Baeyer-Villiger oxidation reaction is provided, more specifically, a catalyst is provided, the catalyst including: a zeolite carrier including micropores and mesopores, and having a hierarchical nanoporous structure; and tin (Sn) loaded onto the zeolite, wherein the diameter of the micropores is 1 nanometer (nm) or less, the diameter of the mesopores is from 2 nm to 10 nm, and a silicon (Si)/Sn ratio is from 20 to 120.

### CROSS-REFERENCE TO RELATED APPLICATION

This application claims priority to Korean Patent Application No. 10-2025-0024551, filed on Feb. 25, 2025, the entire disclosure of which is hereby incorporated herein by reference.

### BACKGROUND

### 1. Field of the Invention

One or more embodiments relate to a catalyst that can be used in a Baeyer-Villiger oxidation reaction and a method of preparing the same.

### 2. Description of the Related Art

Zeolite is a crystalline aluminosilicate material in which micropores with a diameter of less than 2 nm are arranged in a highly regular pattern. Fundamentally, silicon or aluminum is connected via oxygen atoms to form a tetrahedral structure, and depending on the mode of connection, various pore sizes, structures, and frameworks can be formed.

In this way, zeolite not only has a uniform microporous structure that allows it to function as a molecular sieve, but also possesses excellent mechanical and thermal stability, as well as strong acidic sites and ion exchange capacity derived from aluminum atoms within its framework. As a result, zeolite is widely used on its own as an acid catalyst in fields such as petrochemicals. Furthermore, zeolite is also widely used in the preparation of various types of heterogeneous catalysts having high activity for specific organic reactions, by using the zeolite as a carrier and loading or doping metals such as platinum, nickel, or cobalt on the zeolite surface or within its micropores.

Among these heterogeneous catalysts, zeolite catalysts containing tin (Sn) metal are used as catalysts in various organic reactions requiring Lewis acids, such as the Baeyer-Villiger oxidation reaction, the Meerwein-Ponndorf-Verley reduction reaction, and the isomerization reaction of hydrocarbons. These catalysts are known to have high activity, high selectivity, and high stability due to the advantages of the afore-mentioned zeolites.

However, conventional zeolites contain a large number of micropores with very small diameters, leading to a decrease in the diffusion of reactant and product molecules as chemical reactions proceed, resulting in a sharp decline in conversion. Moreover, organic compounds above a certain size are unable to pass through these micropores, preventing them from interacting with active sites and thus exhibiting limited reactivity. To address this, a so-called hierarchical nanoporous zeolite has been synthesized, which includes mesopores with a larger diameter than micropores, in addition to micropores, while simultaneously forming a network in which the micropores are organically interconnected with mesopores. This new structure of zeolite has shown advantages over conventional zeolites in the diffusion of reactants or products larger than a certain size.

Recently, Roman and his colleagues succeeded in synthesizing tin-doped hierarchical nanoporous zeolite catalysts by incorporating a tin precursor during the hydrothermal synthesis of these hierarchical nanoporous zeolites. However, they faced difficulties with the introduction of tin over a certain amount, which made it impossible to synthesize catalysts with a Si/Sn ratio of 125 or less. Additionally, due to the instability of the tin precursor in a liquid environment, a large amount of tin oxide (SnO₂), which is unreactive to the afore-mentioned reactions, was found within the catalyst. [H. Y. Luo, L. Bui, W. R. Gunther, E. Min, Y Román-Leshkov, Synthesis and catalytic activity of Sn-MFI nanosheets for the Baeyer-Villiger oxidation of cyclic ketones, ACS Catal. 2 (2012) 2695-2699]

Therefore, in order to improve the efficiency of processes such as the Baeyer-Villiger oxidation reaction for organic compounds of a certain size or larger, there is a need to develop a new method of preparing a catalyst and a corresponding catalyst, which allows for the introduction of tin in an amount greater than a certain level into hierarchical nanoporous zeolites, while simultaneously enabling the tin to be evenly dispersed on the zeolite and preventing the formation of by-products such as tin oxide within the catalyst.

### SUMMARY

To address the above-described problem, the present disclosure provides a hierarchical nanoporous zeolite-based catalyst in which tin (Sn) metal atoms are uniformly dispersed while the Si/Sn ratio is adjusted to a specific value or less, by synthesizing a zeolite carrier having a hierarchical nanoporous structure and introducing a special post-synthetic method in which the tin (Sn) metal atoms are loaded onto the zeolite carrier.

However, the challenges to be addressed in this specification are not limited to those mentioned above, and other unmentioned challenges will be clearly understood by those skilled in the art from the description below.

An aspect provides a catalyst for a Baeyer-Villiger oxidation reaction, the catalyst including: a zeolite carrier including micropores and mesopores, and having a hierarchical nanoporous structure; and tin (Sn), wherein an average diameter of the micropores may be less than 2 nanometers (nm), an average diameter of the mesopores may be from 2 nm to 10 nm, and a silicon (Si)/Sn ratio may be 20 to 120.

The zeolite carrier may have one or more crystal structures selected from the group consisting of MFI, BEA, MRE and MTW.

The tin (Sn) may have a size of 1 nm or less.

The catalyst for a Baeyer-Villiger oxidation reaction may have a BET specific surface area from 400 m²/g to 800 m²/g, and may have an external specific surface area from 200 m²/g to 600 m²/g.

The catalyst for a Baeyer-Villiger oxidation reaction may have a total pore volume from 0.1 cm³/g to 1.0 cm³/g.

The catalyst for a Baeyer-Villiger oxidation reaction may have a Lewis acid site content due to the tin (Sn) from 20 μmol/g to 150 μmol/g, and the Lewis acid site content due to the tin (Sn) may be measured by ³¹P-solid state nuclear magnetic resonance spectroscopy according to adsorption of trimethylphosphine oxide (TMPO).

Another aspect provides a method of preparing a catalyst for a Baeyer-Villiger oxidation reaction, the method including: synthesizing a borosilicate zeolite having a hierarchical nanoporous structure; synthesizing a zeolite carrier by removing boron (B) from the borosilicate zeolite; and loading tin (Sn) metal onto the zeolite carrier.

The synthesizing of the borosilicate zeolite may include: stirring a solution containing a structure directing surfactant (SDS), a silicon (Si) precursor, and a boron (B) precursor; performing hydrothermal synthesis with the solution to synthesize a borosilicate zeolite; and calcining the synthesized borosilicate zeolite at a temperature from 450° C. to 650° C. under an oxygen (O₂) atmosphere.

The SDS may have a structure represented by Formula 1:

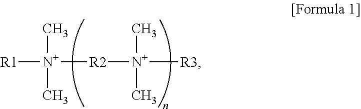

wherein R1 and R3 are each an alkyl group having 3 to 25 carbon atoms, R2 is an alkylene group having 2 to 10 carbon atoms or an arylene group having 6 to 10 carbon atoms, and n is one of the integers from 1 to 10.

The synthesizing of the zeolite carrier may include: mixing the borosilicate zeolite and a nitric acid solution; heating the mixed solution to remove boron from the borosilicate zeolite; and obtaining a zeolite carrier from which boron has been removed.

The loading of the tin (Sn) metal may include: dehydrating the zeolite carrier by heating under vacuum conditions; introducing a tin (Sn) precursor into the dehydrated zeolite carrier to synthesize a tin-loaded zeolite; and calcining the tin-loaded zeolite at a temperature from 450° C. to 650° C. under an oxygen (O₂) atmosphere.

The introducing of the tin (Sn) precursor may include: introducing a tin precursor into the dehydrated zeolite carrier by chemical vapor deposition (CVD).

The tin (Sn) precursor may include one or more of dimethyltin dichloride, trimethyltin chloride, tetramethyltin, butyltin trichloride, butyltin chloride dihydroxide, tributyltin chloride, tetrabutyltin, diphenyltin dichloride, tin dichloride, tin tetrachloride, and tin oxalate.

Additional aspects of embodiments will be set forth in part in the description which follows and, in part, will be apparent from the description, or may be learned by practice of the disclosure.

According to embodiments, the catalyst for a Baeyer-Villiger oxidation reaction includes a zeolite carrier including micropores and mesopores, and having a hierarchical nanoporous structure; and tin (Sn) loaded onto the zeolite carrier, with the Si/Sn ratio being adjusted to a specific value or less, thereby possessing a large number of Lewis acid sites on the catalyst surface and mesopores, resulting in not only high catalytic activity and selectivity for the oxidation reaction of organic substances of a certain size or larger but also excellent thermal stability.

The effect according to an embodiment in this specification is not limited to the afore-mentioned effect, and it should be understood to include all effects that can be inferred from the configuration of the invention described in the detailed description of the invention or the claims of this specification.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram showing the X-ray diffraction (XRD) patterns for catalysts for the Baeyer-Villiger oxidation reaction according to an embodiment.

FIG. 2A is a diagram showing the XRD patterns for catalysts for the Baeyer-Villiger oxidation reaction of the comparative examples (bulk MFI and Sn-bulk MFI).

FIG. 2B is a diagram showing the XRD patterns for catalysts for the Baeyer-Villiger oxidation reaction of the comparative example (Sn-MCM-41).

FIG. 3A is a diagram showing the scanning electron microscopy (SEM) image for catalysts for the Baeyer-Villiger oxidation reaction according to an embodiment (B-MFI-ns).

FIG. 3B is a diagram showing the scanning electron microscopy (SEM) image for catalysts for the Baeyer-Villiger oxidation reaction according to an embodiment (deB-MFI-ns).

FIG. 3C is a diagram showing the scanning electron microscopy (SEM) image for catalysts for the Baeyer-Villiger oxidation reaction according to an embodiment (Sn-MFI-ns-200).

FIG. 3D is a diagram showing the scanning electron microscopy (SEM) image for catalysts for the Baeyer-Villiger oxidation reaction according to an embodiment (Sn-MFI-ns-30).

FIG. 3E is a diagram showing the scanning transmission electron microscopy (STEM) image for catalysts for the Baeyer-Villiger oxidation reaction according to an embodiment (B-MFI-ns).

FIG. 3F is a diagram showing the scanning transmission electron microscopy (STEM) image for catalysts for the Baeyer-Villiger oxidation reaction according to an embodiment (deB-MFI-ns).

FIG. 3G is a diagram showing the scanning transmission electron microscopy (STEM) image and the energy dispersive X-ray spectroscopy (EDS) results for catalysts for the Baeyer-Villiger oxidation reaction according to an embodiment (Sn-MFI-ns-200).

FIG. 3H is a diagram showing the scanning transmission electron microscopy (STEM) image and the energy dispersive X-ray spectroscopy (EDS) results for catalysts for the Baeyer-Villiger oxidation reaction according to an embodiment (Sn-MFI-ns-30).

FIG. 4A is a diagram showing the pore size distribution (PSD) obtained from the nitrogen gas adsorption method for catalysts for the Baeyer-Villiger oxidation reaction according to an embodiment.

FIG. 4B is a diagram showing the pore size distribution (PSD) obtained from the nitrogen gas adsorption method for catalysts for the Baeyer-Villiger oxidation reaction according to an embodiment.

FIG. 4C is a diagram showing the pore size distribution (PSD) obtained from the nitrogen gas adsorption method for catalysts for the Baeyer-Villiger oxidation reaction according to an embodiment.

FIG. 4D is a diagram showing the pore size distribution (PSD) obtained from the nitrogen gas adsorption method for catalysts for the Baeyer-Villiger oxidation reaction according to an embodiment.

FIG. 4E is a diagram showing the pore size distribution (PSD) obtained from the nitrogen gas adsorption method for catalysts for the Baeyer-Villiger oxidation reaction according to an embodiment.

FIG. 4F is a diagram showing the pore size distribution (PSD) obtained from the nitrogen gas adsorption method for catalysts for the Baeyer-Villiger oxidation reaction according to an embodiment.

FIG. 5A is a diagram showing the ¹¹B-solid state NMR spectra of a borosilicate zeolite, according to an embodiment.

FIG. 5B is a diagram showing the ¹¹B-solid state NMR spectra of a zeolite carrier from which boron has been removed, according to an embodiment.

FIG. 6 is a diagram showing the ²⁹Si-solid state NMR spectra of catalysts for the Baeyer-Villiger oxidation reaction according to an embodiment.

FIG. 7 is a diagram showing the ³¹P-solid state NMR spectra according to the adsorption of trimethylphosphine oxide (TMPO) for catalysts for the Baeyer-Villiger oxidation reaction according to an embodiment.

FIG. 8A is a diagram showing the graphs of the conversion of the Baeyer-Villiger oxidation reaction over time for catalysts for the Baeyer-Villiger oxidation reaction of the examples and comparative examples.

FIG. 8B is a diagram showing the graphs of the conversion of the Baeyer-Villiger oxidation reaction over time for catalysts for the Baeyer-Villiger oxidation reaction of the examples and comparative examples.

FIG. 9 is a diagram showing the graphs of the conversion for the Baeyer-Villiger oxidation reaction at different temperatures, for catalysts for the Baeyer-Villiger oxidation reaction of the examples and comparative examples.

### DETAILED DESCRIPTION

Project Unique Number: 2410007820
Project Number: RS-2021-KP002538
Ministry: Ministry of Trade, Industry and Energy (MOTIE), Korea government
Managing Agency: Korea Institute of Energy Technology Evaluation and Planning (KETEP)
R&D Program Title: Core Technology Development for Renewable Energy
R&D Project Title: Cost Effective & High-Efficiency 2,000 kg/day Class Blue Hydrogen Production Unit with CCS
Lead R&D Organization: Wonil T&I Co., Ltd.
Performing Organization: Korea Gas Technology Corporation
Research Period: May 1, 2021-Sep. 30, 2025

Hereinafter, embodiments will be described in detail. However, various alterations and modifications may be made to the embodiments. Here, the embodiments are not construed as limited to the disclosure. The embodiments should be understood to include all changes, equivalents, and replacements within the idea and the technical scope of the disclosure.

For those skilled in the art, the scope of the present disclosure is not limited by these embodiments according to the gist of the present disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, in the description of embodiments, detailed description of well-known related structures or functions will be omitted when it is deemed that such description will cause ambiguous interpretation of the present disclosure.

In addition, the terms first, second, A, B, (a), and (b) may be used to describe constituent elements of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

In the present specification, when one part “includes” one component, this indicates that the part may further include another component instead of excluding another component.

According to an aspect, there is provided a catalyst for the Baeyer-Villiger oxidation reaction, the catalyst including: a zeolite carrier including micropores and mesopores, and having a hierarchical nanoporous structure; and tin (Sn), wherein an average diameter of the micropores may be less than 2 nanometers (nm), an average diameter of the mesopores may be from 2 nm to 10 nm, and a silicon (Si)/Sn ratio may be from 20 to 120. The catalyst according to an embodiment may exhibit not only high catalytic activity and selectivity in an oxidation reaction for organic substances of a certain size or larger by satisfying all of the above conditions but also possesses excellent thermal stability.

The zeolite carrier may be a concept including zeolite or a zeolite-like material containing silicon. The zeolite-like material containing silicon may be a material having the same or similar crystal structure as zeolite, and may include a pure silicate composed only of silicon without aluminum in the aluminosilicate composition of the zeolite, or a metallosilicate in which the aluminum is substituted with another metal atom such as titanium, zirconium, vanadium, iron, lithium, calcium, strontium, germanium, magnesium, or manganese. Additionally, the pure silicate may be prepared as a silicate from the beginning, and may be prepared by removing metal atoms other than silicon from the metallosilicate.

The hierarchical nanoporous structure may be a structure in which, as described above, micropores and mesopores included in a catalyst or carrier are organically connected to form a network so that compounds entering the micropores can move directly into the mesopores or vice versa, and may also be named a ‘nanosponge structure’ in another term.

In addition, the hierarchical nanoporous structure may include a configuration in which, while including micropores, mesopores of very uniform size are formed in a manner that the crystalline frameworks (or crystals), having an ultrathin thickness corresponding to one to ten single unit cells, are organically connected to each other, and the mesopores have a regular hexagonal structure, a cubic structure, or a third irregular structure, such that the micropores and the mesopores are connected with each other and formed together. In addition, the thickness of the crystalline framework may be proportional to the number of single unit cells included in the framework, and may be from 1 nm to 10 nm.

The diameters of the micropores and mesopores may be calculated from an adsorption isotherm measured by a gas adsorption method, and specifically, may be calculated from a maximum point of a pore size distribution (PSD) obtained based on the Barrett-Joyner-Halenda (BJH) algorithm from the adsorption isotherm.

The form in which the tin (Sn) is included in the zeolite carrier may include being loaded onto the outer surface of the zeolite carrier, or being loaded onto the inner wall surfaces of the pores, such as the micropores or mesopores, of the zeolite carrier. The term ‘loading’ may include a form in which a portion of the surface of a tin nanoparticle is in contact with the surface of the zeolite carrier, or a form of doping in which tin at the atomic level is incorporated into the surface framework of the zeolite carrier while a part of the surface of the tin is simultaneously exposed to the outside.

The Si/Sn ratio may be interpreted as an indicator of the amount of tin relative to the total mass of the catalyst, and a smaller value may be interpreted as an increase in the amount of tin relative to the total mass of the catalyst. Additionally, the Si/Sn ratio may be a value measured by analyzing the prepared catalyst using inductively coupled plasma atomic emission spectroscopy (ICP-AES).

The Si/Sn ratio may be from 20 to 120, preferably from 20 to 70, more preferably from 20 to 50, and most preferably from 20 to 40. If the Si/Sn ratio exceeds the upper limit of the above range, the amount of tin in the catalyst may be too small, failing to achieve the target conversion or the reaction may not proceed at all. If the Si/Sn ratio is less than the lower limit of the above range, tin may not be evenly distributed in the catalyst, the size of the tin particles may become very large, causing a rapid decrease in the conversion per metal mass, and some micropores may be blocked, preventing proper diffusion of the reactants/products.

The Baeyer-Villiger oxidation reaction is an organic reaction in which an oxygen atom is added to a position immediately adjacent to the alpha carbon of the carbonyl (C═O) group of a ketone or aldehyde compound. Depending on the type of acid site acting as a catalyst, the reaction may proceed either as a main reaction (see Reaction 1 below) or as a side reaction (see Formula 2 below). It is known that the main reaction is usually performed by a Lewis acid site, whereas the side reaction is performed by a Brönsted acid site. Therefore, in order to obtain a product according to the main reaction, it can be seen that it is advantageous for there to be sufficient Lewis acid sites in the catalyst and for there to be as few Brönsted acid sites as possible.

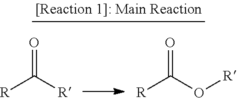

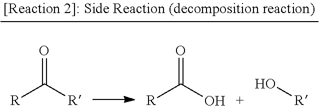

According to an embodiment, the zeolite carrier may have one or more crystal structures selected from the group consisting of MFI, BEA, MRE and MTW. The crystal structures may be derived from the nomenclature defined by the International zeolite association (IZA). Additionally, the zeolite carrier may have a single crystal structure, or may have multiple crystal structures such as primary phases, secondary phases, or the like.

According to an embodiment, the tin (Sn) may have a size of 1 nm or less.

A catalyst according to an embodiment may include tin that is atomically dispersed in a size of 1 nm or less, or at an atomic level, in the zeolite carrier, by being prepared by the preparation method according to the embodiment described below. That is, even if the amount of tin included in the catalyst is increased to a certain level or more, byproducts such as excessively large tin particles or tin oxide may not be generated, and the effect of increasing the activity of tin, which acts as a Lewis acid site, may also be maintained as the size of the tin particles decreases. Furthermore, the size of the tin may be measured through images obtained from a high-resolution scanning transmission electron microscope (STEM) and energy dispersive X-ray spectroscopy (EDS).

In an embodiment, the catalyst for the Baeyer-Villiger oxidation reaction may have a BET specific surface area from 400 m²/g to 800 m²/g, or from 500 m²/g to 800 m²/g, or from 500 m²/g to 700 m²/g, or from 600 m²/g to 700 m²/g. Additionally, the catalyst for the Baeyer-Villiger oxidation reaction may have an external specific surface area from 200 m²/g to 600 m²/g, from 300 m²/g to 600 m²/g, from 300 m²/g to 500 m²/g, or from 400 m²/g to 500 m²/g.

In an embodiment, the catalyst for the Baeyer-Villiger oxidation reaction may have a total pore volume from 0.1 cm³/g to 1.0 cm³/g, from 0.3 cm³/g to 1.0 cm³/g, from 0.5 cm³/g to 1.0 cm³/g, or from 0.5 cm³/g to 0.8 cm³/g.

A catalyst according to an embodiment has the characteristics of having a zeolite carrier having a hierarchical nanoporous structure, and thus has a considerably large BET specific surface area and external specific surface area as well as a very large pore volume, thereby securing a large space in which reactants can be located within the catalyst, while Lewis acid sites existing on the surface of the zeolite crystals can easily come into contact with reactants.

The BET specific surface area, external specific surface area, and total pore volume may be calculated from an adsorption isotherm according to a gas adsorption method. Specifically, the BET specific surface area may be calculated from the adsorption amount in the section of the adsorption isotherm where the relative pressure (P/P₀) is from 0.05 to 0.20, the external specific surface area may be calculated from the adsorption isotherm using the t-plot method, and the total pore volume may be calculated from the adsorption amount at the point on the adsorption isotherm where the relative pressure is 0.95.

According to an embodiment, the catalyst for the Baeyer-Villiger oxidation reaction may have a Lewis acid site content due to the tin (Sn) from 20 μmol/g to 150 μmol/g, preferably from 45 μmol/g to 150 μmol/g, more preferably from 60 μmol/g to 150 μmol/g, more preferably from 90 μmol/g to 150 μmol/g, and most preferably from 120 μmol/g to 150 μmol/g.

A catalyst according to an embodiment not only contains a large amount of tin, which acts as a Lewis acid site, but also has tin particles evenly distributed on a zeolite phase or within a zeolite framework. This is so that it can have optimal catalytic activity conditions for a reaction with an organic compound. Therefore, the Lewis acid site content may be a primary indicator of the performance of the catalyst.

In addition, the Lewis acid site content due to the tin (Sn) may be measured by ³¹P-solid state nuclear magnetic resonance spectroscopy according to adsorption of trimethylphosphine oxide (TMPO). Specifically, after adsorbing a TMPO probe molecule onto a target catalyst material, a spectrum in which one or more peaks appear is obtained for the adsorbed catalyst material through ³¹P-solid-state nuclear magnetic resonance spectroscopy, and then the peaks corresponding to Lewis acid sites are quantitatively analyzed, and the Lewis acid site content due to the tin (Sn) may be calculated from the measured value.

According to another aspect, there is provided a method of preparing a catalyst for a Baeyer-Villiger oxidation reaction, the method including: synthesizing a borosilicate zeolite having a hierarchical nanoporous structure; synthesizing a zeolite carrier by removing boron (B) from the borosilicate zeolite; and loading tin (Sn) metal onto the zeolite carrier. In this way, a catalyst prepared by introducing a post-synthetic method of performing a post-treatment on a synthesized borosilicate zeolite may have the characteristics of a Si/Sn ratio of 120 or less, contrary to a catalyst prepared based on a conventional single-step hydrothermal synthesis method, and may also have the characteristics of evenly dispersing tin having a size of 1 nm or less while not including by-products such as tin oxide.

According to an embodiment, the synthesizing of a borosilicate zeolite may include: stirring a solution containing a structure directing surfactant (SDS), a silicon (Si) precursor, and a boron (B) precursor; performing hydrothermal synthesis with the solution to synthesize a borosilicate zeolite; and calcining the synthesized borosilicate zeolite at a temperature from 450° C. to 650° C. under an oxygen (O₂) atmosphere.

During the stirring of the solution, a hydrophilic part of the surfactant interacts with the inorganic precursor to induce gel formation, and hydrophobic parts interact with each other through non-covalent bonding (such as van der Waals forces), thereby allowing the gel to form a specific structure. Moreover, the solution may further contain an alkali metal precursor such as sodium (Na) or potassium (K), and the resulting zeolite crystal structure may change depending on the composition of the components included in the solution.

According to an embodiment, the SDS may have a structure represented by Formula 1:

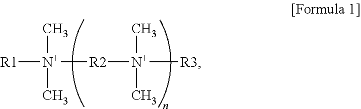

wherein R1 and R3 are each an alkyl group having 3 to 25 carbon atoms, R2 is an alkylene group having 2 to 10 carbon atoms or an arylene group having 6 to 10 carbon atoms, and n is one of the integers from 1 to 10.

The SDS is the most essential component for synthesizing a zeolite having a hierarchical nanoporous structure, contrary to conventional zeolites, and must have at least two ammonium functional groups in its structure, and the thickness of the resulting zeolite crystal framework may increase depending on the number of ammonium functional groups. Also, by changing the number of ammonium functional groups of the surfactant, the type and length of the hydrocarbon chain, and the like, micropores and mesopores having various structures and arrangements may be formed.

In the performing of the hydrothermal synthesis, the organic/inorganic composite gel produced in the previous operation is converted into a borosilicate zeolite through a crystallization process induced from high-temperature and high-pressure steam, and the synthesized borosilicate zeolite may be obtained by filtration or centrifugation.

In the calcining of the synthesized borosilicate zeolite, organic substances such as the SDS may be removed, and covalent bonds within the zeolite framework may be formed and rearranged, resulting in an increase in the structural density.

According to an embodiment, the synthesizing of the zeolite carrier may include: mixing the borosilicate zeolite and a nitric acid solution; heating the mixed solution to remove boron from the borosilicate zeolite; and obtaining a zeolite carrier from which boron has been removed.

In the mixing of the borosilicate zeolite and nitric acid solution, the nitric acid solution may be an aqueous solution having a concentration from 0.5 M to 0.2 M, may be used in an amount from 20 ml to 100 ml per 1 g of borosilicate zeolite, and may be used by appropriately selecting a value capable of removing all boron from the borosilicate zeolite within the temperature and volume ranges described above.

When heating the mixed solution, the solution may be heated at a temperature within the range from 40° C. to 80° C. for 3 to 12 hours, and similarly, a value may be appropriately selected within the above temperature and time ranges to enable complete removal of boron from the borosilicate zeolite. The zeolite carrier prepared by removing boron as described above may be a silicate containing a silanol group (Si—OH) at the site where boron is removed.

According to an embodiment, the loading of the tin (Sn) metal may include: dehydrating the zeolite carrier by heating under vacuum conditions; introducing a tin (Sn) precursor into the dehydrated zeolite carrier to synthesize a tin-loaded zeolite; and calcining the tin-loaded zeolite at a temperature from 450° C. to 650° C. under an oxygen (O₂) atmosphere.

The dehydrating of the zeolite carrier may include heating the zeolite carrier under vacuum conditions at a temperature within the range from 300° C. to 500° C. for 3 to 12 hours, during which water molecules physically adsorbed in the micropores and mesopores of the zeolite carrier may be removed.

According to an embodiment, the introducing of the tin (Sn) precursor may include: introducing a tin precursor into the dehydrated zeolite carrier by chemical vapor deposition (CVD). Specifically, the tin precursor may have any phase of solid, liquid, or gas; however, when the tin precursor is a solid, a mixture may first be prepared by sufficiently and uniformly mixing the zeolite carrier and the tin precursor in the solid state, and then the mixture may be heated under vacuum conditions at a temperature within the range from 300° C. to 500° C. so that the tin precursor converted into a gaseous phase comes into contact with silanol groups of the zeolite carrier, thereby synthesizing a tin (Sn)-loaded zeolite.

According to an embodiment, the tin (Sn) precursor may include one or more of dimethyltin dichloride, trimethyltin chloride, tetramethyltin, butyltin trichloride, butyltin chloride dihydroxide, tributyltin chloride, tetrabutyltin, diphenyltin dichloride, tin dichloride, tin tetrachloride, and tin oxalate, and preferably may include dimethyltin dichloride.

Hereinafter, the present disclosure will be described in more detail with reference to examples. The following examples are provided for the purpose of illustrating the present disclosure and are not intended to limit the scope of the present disclosure.

### Preparation Example: Preparation of a Catalyst for the Baeyer-Villiger Oxidation Reaction

### Example 1

### (1) Preparation of a Hierarchical Nanoporous Borosilicate Zeolite (B-MFI-Ns)

[C₁₈H₃₇—N⁺(CH₃)₂—C₆H₁₂—N⁺(CH₃)₂—C⁶H₁₃][Br⁻]₂ was added to a reaction vessel as an SDS, tetraorthosilicate was added as a Si source, boric acid was added as a B source, and sodium hydroxide was added as a Na source, and then sulfuric acid and water were added and mixed to form a gel having a composition of ‘100 SiO₂/3.3 B(OH)₃/7.5 SDS/30 Na₂O/18 H₂SO₄/5000 H₂O (mole ratio)’. The formed gel was placed in an autoclave and hydrothermal synthesis was performed at 150° C. for 46 hours, and the synthesized borosilicate zeolite was obtained in the form of a powder through a series of processes including washing with distilled water, filtration, and drying. Finally, the obtained borosilicate zeolite was calcined at a temperature of 550° C. in an oxygen (O₂) atmosphere to prepare and obtain a final borosilicate zeolite (crystal structure: MFI), which was named ‘B-MFI-ns’.

(2) Preparation of a Hierarchical Nanoporous Silicate (deB-MFI-Ns) from which Boron has been Removed

The above-mentioned prepared borosilicate zeolite (B-MFI-ns) was added to a 0.1 M nitric acid (HNO₃) aqueous solution and mixed at 60° C. for 6 hours. The nitric acid-treated sample was obtained in the form of a powder through a series of processes including washing with distilled water, filtration, and drying. The nitric acid treatment and drying process described above was repeated two more times to prepare and obtain a hierarchical nanoporous zeolite carrier (silicate) from which boron had been removed, which was named ‘deB-MFI-ns’.

### (3) Preparation of a Catalyst for the Baeyer-Villiger Oxidation Reaction Containing Tin (Sn)

The above-mentioned hierarchical nanoporous zeolite carrier from which boron had been removed (deB-MFI-ns) was dehydrated under vacuum conditions at a temperature of 400° C. for 6 hours. The dehydrated sample and dimethyltin dichloride were mixed in the solid state at a Si/Sn ratio of 200, and the mixture was placed in a reactor and heat-treated under vacuum conditions at a temperature of 550° C. for 6 hours. The heat-treated sample was calcined at 550° C. in an oxygen (O₂) atmosphere to finally prepare and obtain a catalyst for the Baeyer-Villiger oxidation reaction, which was named ‘Sn-MFI-ns-200’. (Note: The numbers following Sn-MFI-ns are named with reference to the Si/Sn ratio according to the ICP-AES results of Experimental Example 1 below.)

### Example 2

In the ‘(3) Preparation of a Catalyst for the Baeyer-Villiger Oxidation Reaction Containing Tin (Sn)’ of Example 1, a catalyst for the Baeyer-Villiger oxidation reaction was prepared and obtained in the same manner as in Example 1, except that the dehydrated sample and dimethyltin dichloride were mixed in the solid state at a Si/Sn ratio of 120, which was named ‘Sn-MFI-ns-120’.

### Example 3

In the ‘(3) Preparation of a Catalyst for the Baeyer-Villiger Oxidation Reaction Containing Tin (Sn)’ of Example 1, a catalyst for the Baeyer-Villiger oxidation reaction was prepared and obtained in the same manner as in Example 1, except that the dehydrated sample and dimethyltin dichloride were mixed in the solid state at a Si/Sn ratio of 70, which was named ‘Sn-MFI-ns-60’.

### Example 4

In the ‘(3) Preparation of a Catalyst for the Baeyer-Villiger Oxidation Reaction Containing Tin (Sn)’ of Example 1, a catalyst for the Baeyer-Villiger oxidation reaction was prepared and obtained in the same manner as in Example 1, except that the dehydrated sample and dimethyltin dichloride were mixed in the solid state at a Si/Sn ratio of 30, which was named ‘Sn-MFI-ns-30’.

### Comparative Example 1

SnCl₄·5H₂O was added as a Sn source, and tetraethyl orthosilicate was added as a Si source. Tetra-n-propyl ammonium hydroxide (TPAOH) and distilled water were added and then mixed to form a gel having a composition of ‘0.03 SnO₂/1 SiO₂/0.45 TPAOH/35 H₂O’. The formed gel was placed in an autoclave and hydrothermal synthesis was performed at 150° C. for 48 hours to synthesize microporous zeolite, and the synthesized zeolite was obtained in the form of a powder through a series of processes including washing with distilled water, filtration, and drying. The obtained zeolite was calcined at a temperature of 480° C. for 10 hours in an oxygen (O₂) atmosphere to finally prepare and obtain a microporous zeolite (crystal structure: MFI) containing tin (Sn), which was named ‘Sn-bulk-MFI’.

### Comparative Example 2

Fumed silica was added as a Si source, tetramethylammonium hydroxide (TMAOH) was added and mixed, then SnCl₄·5H₂O was added as a Sn source, and distilled water and hexadecyltrimethylammonium bromide (CTABR) were added and mixed to form a gel having a composition of ‘1 SiO₂/0.01 SnCl₄/0.24 CTABR/0.3 TMAOH/25 H₂O’. The formed gel was placed in an autoclave and hydrothermal synthesis was performed at 90° C. for 72 hours, and the synthesized mesoporous silica was obtained in the form of a powder through a series of processes including washing with distilled water, filtration, and drying. The obtained sample was calcined at a temperature of 480° C. for 10 hours in an oxygen (O₂) atmosphere to finally prepare and obtain a mesoporous silica (MCM-41 structure) containing tin (Sn), which was named ‘Sn-MCM-41’.

### Experimental Example 1: ICP-AES Analysis

For the catalyst samples of the examples and comparative examples according to the above-mentioned preparation examples, ICP-AES analysis was performed to measure the Si/Sn ratio, and the results are shown in Table 1 below.

TABLE 1

| | Sample Name | Si/Sn ratio |
|---|---|---|
| Example 1 | Sn-MFI-ns-200 | 200 |
| Example 2 | Sn-MFI-ns-120 | 120 |
| Example 3 | Sn-MFI-ns-60 | 63 |
| Example 4 | Sn-MFI-ns-30 | 27 |
| Comparative | Sn-bulk-MFI | 33 |
| Example 1 | | |
| Comparative | Sn-MCM-41 | 55 |
| Example 2 | | |

Referring to Table 1, it was first confirmed that all of the catalysts of the examples and comparative examples contained tin (Sn). In particular, for the catalysts of Examples 1 to 4, it was confirmed that as the Si/Sn ratio of the materials introduced during the preparation process decreased, the Si/Sn ratio of the prepared catalysts also decreased proportionally.

### Experimental Example 2: X-ray Diffraction (XRD) Analysis

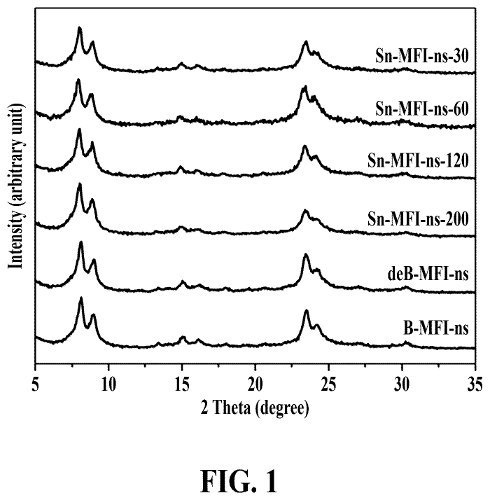

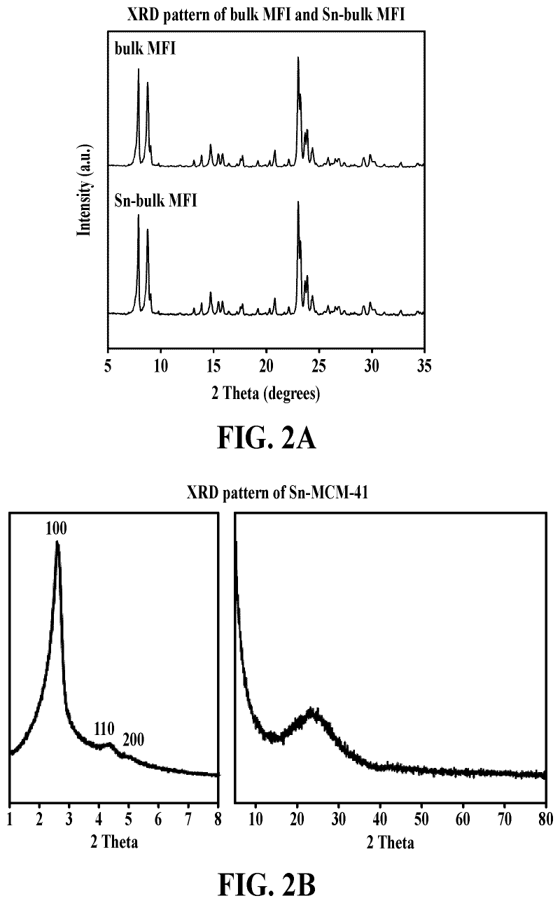

XRD patterns were collected for the catalysts of the examples and comparative examples, as well as for the ‘B-MFI-ns’ and ‘deB-MFI-ns’ materials generated during the catalyst synthesis of the examples among the above-mentioned preparation examples, using a Rigaku Multiflex diffractometer under Cu-Kα radiation within the range from of 2θ=5° to 40°. Among these, the XRD patterns for the ‘B-MFI-ns’ and ‘deB-MFI-ns’ materials and the catalysts of Examples 1 to 4 are shown in FIG. 1, and the XRD patterns for Comparative Examples 1 and 2 are shown in FIGS. 2A and 2B.

First, all XRD patterns in FIG. 1 have peaks corresponding to the MFI crystal structure, indicating that a zeolite material having an MFI structure was successfully synthesized as a whole. In addition, the absence of broad peaks within the range of 2θ=20° to 30° confirms that amorphous silica was not synthesized separately. Additionally, the absence of significant changes in the XRD pattern peaks before and after boron removal or tin loading confirms that the crystal structure was well maintained without collapsing, despite the high-temperature treatments during the synthesis process.

Also, referring to FIG. 2A, the XRD pattern of Comparative Example 1 has peaks corresponding to the MFI crystal structure, which confirms that Comparative Example 1 is also a material having an MFI zeolite structure. Based on the fact that the XRD peaks in FIG. 1 are much broader (i.e., have a greater full width at half maximum) than those in FIG. 2A, it can be understood that the catalysts of Examples 1 to 4 are formed of very small zeolite crystals, whereas the catalysts of Comparative Example 1 are formed of bulk zeolite that is relatively much greater in size.

Lastly, referring to FIG. 2B, the XRD pattern of Comparative Example 2 has not only peaks within the range of 20<5° derived from the regular arrangement of mesopores according to the MCM-41 structure, but also broad peaks within the range of 2θ=20° to 30° that appear from the amorphous silica walls of the mesopores, which confirms that the MCM-41 material was successfully synthesized.

### Experimental Example 3: Shape Observation Using an Electron Microscope and EDS Analysis

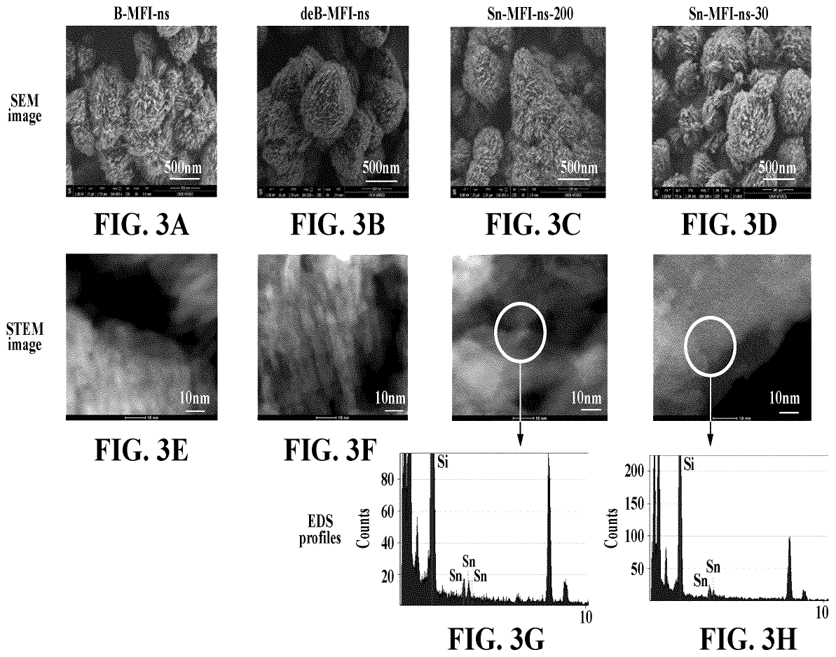

For the catalyst samples of Examples 1 and 4 (Sn-MFI-ns-200 and 30), along with the ‘B-MFI-ns’ and ‘deB-MFI-ns’ samples generated during the catalyst synthesis of the examples among the above-mentioned preparation examples, scanning electron microscopy (SEM) and STEM images were taken and observed. For the catalyst samples of Examples 1 and 4, EDS analysis was performed on the regions in the STEM images where tin (Sn) particles were presumed to be present. The SEM and STEM images and the results of the EDS analysis are shown in FIG. 3A to FIG. 3H.

First, referring to the SEM and STEM images of each sample in FIG. 3A to FIG. 3H, it can be confirmed that zeolite crystals having a thickness of approximately 10 nm or less are randomly arranged to form mesopores, and based on this, it was directly confirmed that zeolite having a hierarchical nanoporous structure (or nanosponge structure) was successfully synthesized. In addition, as shown in the XRD pattern analysis results of Experimental Example 2, it was also confirmed that the zeolite crystals did not collapse throughout the synthesis process and that the hierarchical nanoporous structure was well maintained.

Furthermore, referring to the STEM images (FIG. 3G and FIG. 3H) of the catalysts of Examples 1 and 4, contrary to the STEM images (FIG. 3E and FIG. 3F) of the ‘B-MFI-ns’ and ‘deB-MFI-ns’ samples, bright spots having a size of 1 nm or less were uniformly dispersed, and through EDS analysis of the corresponding regions, it was confirmed that the bright spots corresponded to tin (Sn). That is, based on the STEM and EDS analyses, it was confirmed that not only the catalyst of Example 1 (Sn-MFI-ns-200), but also the catalyst of Example 4 (Sn-MFI-ns-30), in which the Sn content relative to Si was the highest, uniformly contained extremely small tin particles of 1 nm or less or at the atomic level.

### Experimental Example 4: Nitrogen (N₂) Gas Adsorption Analysis

For the catalyst materials of the examples and comparative examples, along with the ‘B-MFI-ns’ and ‘deB-MFI-ns’ samples generated during the catalyst synthesis of the examples among the above-mentioned preparation examples, nitrogen gas adsorption was performed at 77 K using a Micromeritics TriStar 3000 volumetric adsorption analyzer to obtain adsorption isotherms, and based on the isotherms, the BET specific surface area (S_{BET}), external specific surface area (Sₑₓₜ), and total pore volume (Vₜₒₜ) were calculated.

Specifically, the BET specific surface area was calculated from the adsorption amount in the section of the adsorption isotherm where the relative pressure (P/P₀) is from 0.05 to 0.20, the external specific surface area was calculated from the adsorption isotherm using the t-plot method, and the total pore volume was calculated based on the adsorption amount at the point on the adsorption isotherm where the relative pressure is 0.95. The results are shown in Table 2 below.

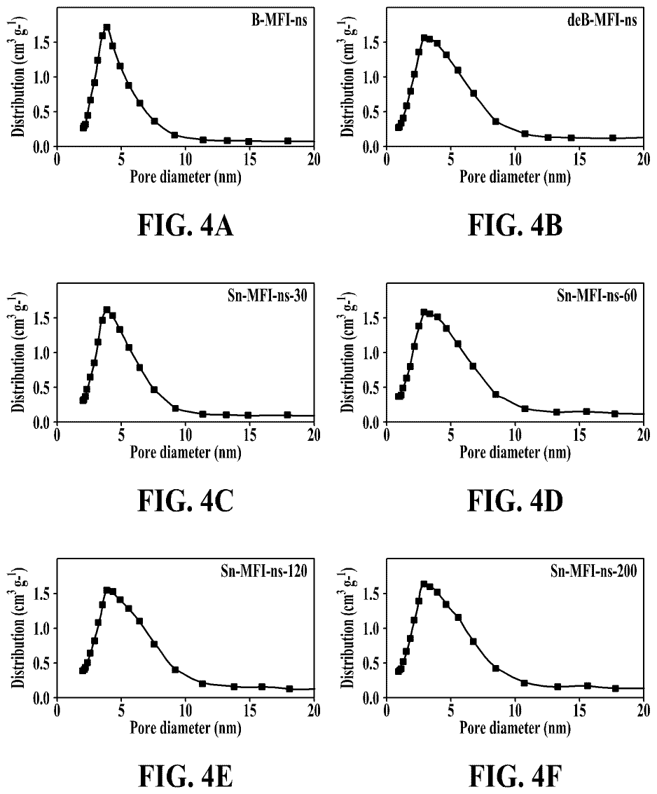

In addition, for the catalyst materials of ‘B-MFI-ns (Reference Example 1 below)’, ‘deB-MFI-ns (Reference Example 2 below)’, and Examples 1 to 4, PSDs calculated from the adsorption isotherms based on the Barrett-Joyner-Halenda (BJH) algorithm were obtained, and the results are shown in FIG. 4A to FIG. 4F.

TABLE 2

| | Sample Name | S_{BET}(m²/g) | Sₑₓₜ(m²/g) | Vₜₒₜ(cm³/g) |
|---|---|---|---|---|
| Reference | B-MFI-ns | 670 | 480 | 0.65 |
| Example 1 | | | | |
| Reference | deB-MFI-ns | 640 | 450 | 0.65 |
| Example 2 | | | | |
| Example 1 | Sn-MFI-ns-200 | 640 | 470 | 0.72 |
| Example 2 | Sn-MFI-ns-120 | 630 | 460 | 0.70 |
| Example 3 | Sn-MFI-ns-60 | 630 | 450 | 0.66 |
| Example 4 | Sn-MFI-ns-30 | 630 | 470 | 0.65 |
| Comparative | Sn-bulk-MFI | 300 | 20 | 0.14 |
| Example 1 | | | | |
| Comparative | Sn-MCM-41 | 1,435 | 1,015 | 1.04 |
| Example 2 | | | | |

Referring to Table 2, it was confirmed that the catalyst materials of Reference Example 1 (‘B-MFI-ns’) and Reference Example 2 (‘deB-MFI-ns’) through Examples 1 to 4 (Sn-MI-ns series) not only have large BET specific surface areas and external specific surface areas derived from the zeolite nanocrystals and their micropores, but also have large pore volumes derived from the micropores and mesopores. In addition, based on the PSDs shown in FIG. 4A to FIG. 4F, the materials of the reference examples and examples were all found to possess mesopores having a size from 2 nm to 10 nm, and as confirmed from the SEM and STEM images in Experimental Example 3, all of them were shown to have a hierarchical nanoporous structure.

Furthermore, considering that the materials of the reference examples and examples almost consistently maintained the specific surface areas and pore volumes shown in Table 1 as well as the shape of the PSDs in FIG. 4A to FIG. 4F, it was confirmed once again that the unique hierarchical nanoporous structure of the materials was hardly damaged throughout the synthesis process.

### Experimental Example 5: Solid State Nuclear Magnetic Resonance (NMR) Spectroscopy Analysis

### (1) ¹¹B-Solid State NMR Analysis

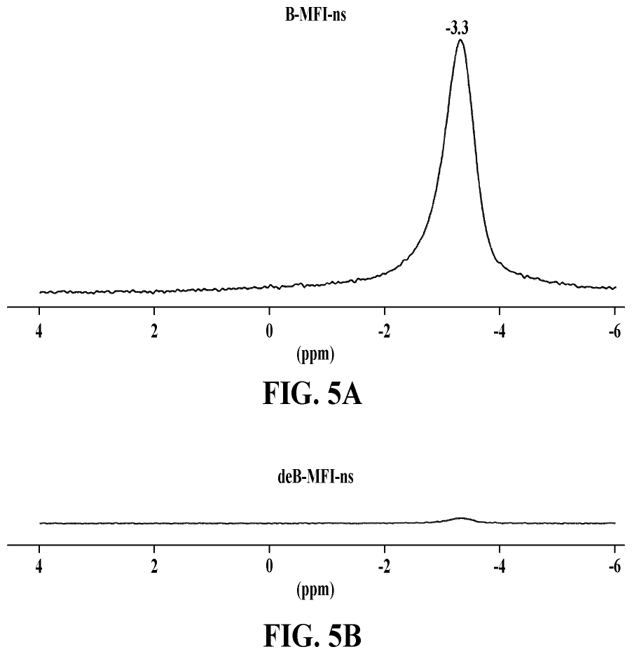

For the ‘B-MFI-ns’ and ‘deB-MFI-ns’ materials generated during the catalyst synthesis of the examples among the above-mentioned preparation examples, ¹¹B-Solid-state NMR analysis was performed, and the resulting spectra are shown in FIG. 5A and FIG. 5B.

Referring to FIG. 5A and FIG. 5B, the B-MFI-ns material shows a single peak (chemical shift=−3.3 ppm) corresponding to boron with tetrahedral oxygen coordination, whereas in the deB-MFI-ns material, which underwent a boron removal, the corresponding peak is hardly observed. Therefore, it was confirmed from the boron removal in the above-mentioned preparation example that the boron in the borosilicate zeolite was almost completely removed.

### (2)²⁹Si-Solid State NMR Analysis

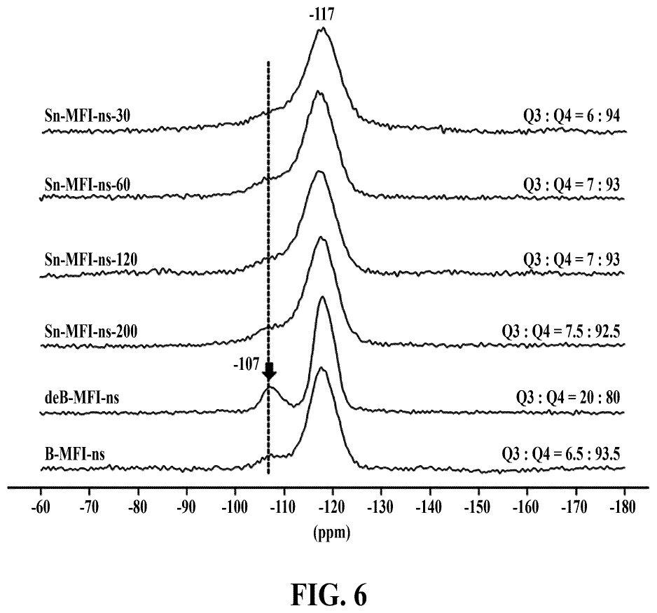

For the catalyst materials of Examples 1 to 4, along with the ‘B-MFI-ns’ and ‘deB-MFI-ns’ materials generated during the catalyst synthesis of the examples among the above-mentioned preparation examples, ²⁹Si-solid state NMR analysis was performed, and the resulting spectra are shown in FIG. 6. For reference, in the spectra, Q3 (chemical shift=−107 ppm) is the peak for the central Si of the Si(OSi)₃OH unit, and Q4 (chemical shift=−117 ppm) is the peak for the central Si of the Si(OSi)₄ unit.

Referring to FIG. 6, first, it can be seen that the ratio of the Q3 peak intensity to the Q4 peak intensity in the deB-MFI-ns material significantly increased compared to that in the B-MFI-ns material. From this, it was found that, through the boron removal process of the above-mentioned preparation example, a large number of silanol groups (Si—OH) were generated simultaneously with the removal of boron.

In addition, compared to the deB-MFI-ns material, ‘the ratio of the Q3 peak intensity to the Q4 peak intensity’ in the Sn-MFI-ns series materials of Examples 1 to 4 decreased again, suggesting that the silanol groups were reduced as they interacted with the tin precursor and the tin (Sn) particles were introduced into the silanol group sites. Furthermore, considering that the ratio of the Q3 peak intensity to the Q4 peak intensity in Examples 1 to 3, which contain less tin than Example 4, was similar to that of Example 4, it could also be inferred that the silanol groups that were not used for tin introduction were converted back into oxygen bridges (Si—O—Si) during the heat treatment process or the like.

By combining these analytical results with the STEM and EDS analysis results of Experimental Example 3, it could be inferred that, due to the formation of silanol groups resulting from the post-synthetic method of ‘boron removal and Sn introduction’ in the above-mentioned preparation example, tin particles of 1 nm or less or at the atomic level could be uniformly distributed throughout the zeolite carrier, and that catalysts with a lower Si/Sn ratio than conventional catalysts could thus be synthesized.

(3) ³¹P-Solid State NMR Analysis according to Trimethylphosphine Oxide (TMPO) Adsorption

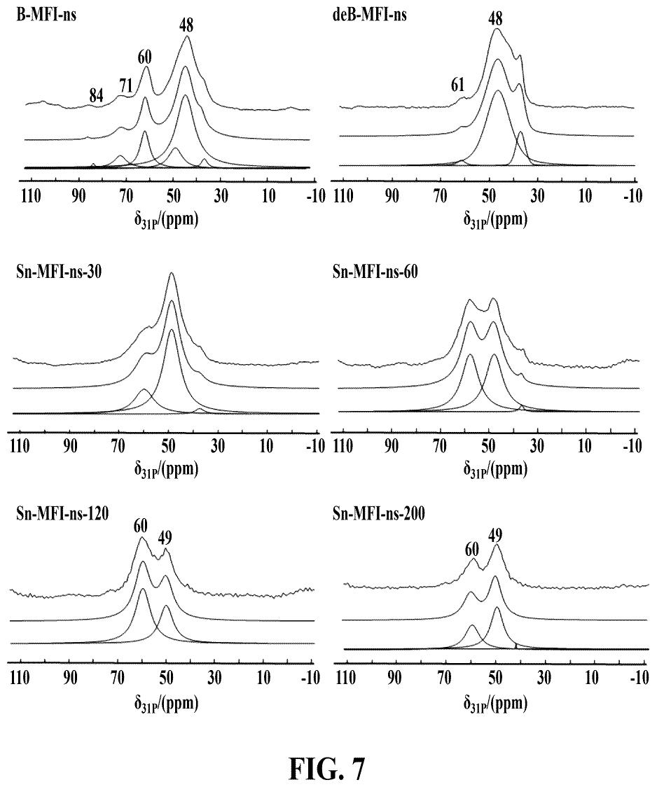

For the catalyst materials of Examples 1 to 4, along with the ‘B-MFI-ns’ and ‘deB-MFI-ns’ materials generated during the catalyst synthesis of the examples among the above-mentioned preparation examples, dehydration was performed at a temperature of 550° C. for 6 hours under vacuum conditions. The dehydrated materials were mixed with TMPO in a glove box to perform TMPO adsorption, and heat treatment was performed at 150° C. for 2 hours to induce uniform adsorption of TMPO. ³¹P-solid state NMR analysis was performed on the materials adsorbed with TMPO, and the resulting spectra are shown in FIG. 7.

First, referring to the spectra for B-MFI-ns in FIG. 7, it can be seen that peaks corresponding to TMPO adsorbed on strong Brönsted acid sites (chemical shift=84 ppm, 71 ppm) are observed, along with a peak corresponding to TMPO adsorbed on weak Brönsted acid sites and Lewis acid sites (chemical shift=60 ppm). (Note: the peak at a chemical shift of 48 ppm is a peak corresponding to physically adsorbed TMPO.) This can be considered to be derived from the boron in the material.

In contrast, referring to the spectra for deB-MFI-ns, it can be observed that the peaks corresponding to the Brönsted acid sites and Lewis acid sites derived from boron significantly decreased as a result of the boron removal.

Referring to the spectra for the Sn-MFI-ns series (Examples 1 to 4), it can be observed that the peak corresponding to the Lewis acid sites (chemical shift=60 ppm) increased again with the introduction of tin. The Lewis acid site content derived from tin per unit mass of catalyst (LAₜₒₜ), calculated from the corresponding peak, is summarized and shown in Table 3 below.

TABLE 3

| | Sample Name | LAₜₒₜ(μmol/g) |
|---|---|---|
| Example 1 | Sn-MFI-ns-200 | 13 |
| Example 2 | Sn-MFI-ns-120 | 41 |
| Example 3 | Sn-MFI-ns-60 | 86 |
| Example 4 | Sn-MFI-ns-30 | 130 |

From the results in Table 3, it was confirmed that, as the Si/Sn ratio of the raw materials used in the preparation of the Sn-MFI-ns series decreased, the Lewis acid site content derived from tin also increased proportionally, which was found to correspond to the results derived from the ICP-EAS analysis in Experimental Example 1.

### Experimental Example 6: Evaluation of Catalytic Activity for the Baeyer-Villiger Oxidation Reaction of 2-Adamatanone

For 50 mg of each catalyst of the examples and comparative examples according to the above-mentioned preparation examples, 2 mmol of 2-adamantanone, 2 mmol of hydrogen peroxide (H₂O₂), and 6 mL of 1,4-dioxane solvent were added to a reactor, and the Baeyer-Villiger oxidation reaction was performed at 80° C. Then, a portion of the reaction solution was collected at regular time intervals, and the components of the reaction solution were analyzed using gas chromatography.

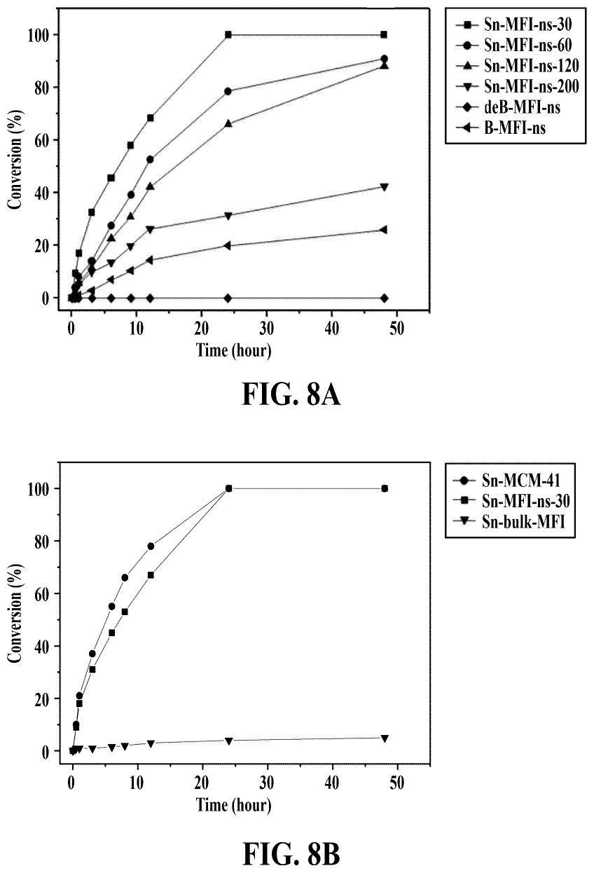

Among the results, the conversion and selectivity when 3 hours had elapsed, as well as the turnover frequency per unit mass of catalyst when 1 hour had elapsed, were calculated and are shown in Table 4 below. A graph of the conversion over time is shown in FIG. 8A and FIG. 8B.

TABLE 4

| | | | | Turnover |
|---|---|---|---|---|
| | | Conversion | Selectivity | Frequency |
| | Sample Name | (%) | (%) | (mmol/g_{cat} · h) |
| Example 1 | Sn-MFI-ns-200 | 10.0 | >99 | 2 |
| Example 2 | Sn-MFI-ns-120 | 12.5 | >99 | 2.4 |
| Example 3 | Sn-MFI-ns-60 | 15.0 | >99 | 3.2 |
| Example 4 | Sn-MFI-ns-30 | 33.0 | >99 | 6.8 |
| Comparative | Sn-bulk-MFI | 0.0 | — | — |
| Example 1 | | | | |
| Comparative | Sn-MCM-41 | 39.0 | >99 | 8.2 |
| Example 2 | | | | |

The 2-adamantanone used as a reactant in the above oxidation reaction has the molecular structure of Formula 2 below, and is known to have a volume that is difficult to pass through the micropores of conventional MFI zeolites.

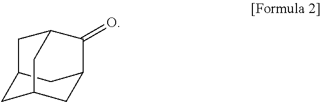 [SMILES: O=C1C2CC3CC(C2)CC1C3]

Accordingly, the conversion of the catalyst of Comparative Example 1 (Sn-bulk-MFI), in which a substantial amount of tin particles are distributed in the micropores, was found to be 0% when 3 hours had elapsed. As shown in the graph of FIG. 8B, the conversion did not exceed 10% even after approximately 48 hours had elapsed. That is, this can be considered to indicate that conventional microporous zeolite-based catalysts are unsuitable for the oxidation reaction of bulky organic substances.

In contrast, it was found that the catalysts of Examples 1 to 4 (Sn-MFI-ns series), which have a hierarchical nanoporous structure, exhibited relatively higher conversion compared to Comparative Example 1, as shown in the results of Table 4. This is due to the tin particles distributed on the surfaces of numerous nano-sized zeolite crystals or on the walls of the mesopores. It was also confirmed that the conversion increased proportionally as the Si/Sn ratio decreased (i.e., as the Sn content relative to Si increased), and this trend was also observed in the conversion versus time graph in FIG. 8A. In particular, among the catalysts of Examples 1 to 4, Example 4 (Sn-MFI-ns-30), which had the lowest Si/Sn ratio, reached 100% conversion most quickly, in approximately 24 hours, and exhibited the best catalytic performance among the examples. This result directly confirmed the effect of the amount of acid sites on the catalytic performance. In addition, since the tin particles act as Lewis acid sites rather than Brönsted acid sites, almost no side reactions occurred in the Baeyer-Villiger oxidation reaction, and it was confirmed from the results in Table 4 that all of the catalysts of Examples 1 to 4 exhibited a selectivity of 99% or higher.

According to Table 4 and the graph in FIG. 8B, it can be confirmed that the catalyst of Example 4 (Sn-MFI-ns-30) exhibited a performance slightly lower than, but nearly comparable to, that of the catalyst of Comparative Example 2 (Sn-MCM-41). In relation to this, according to the ICP-AES results of Experimental Example 1, the Si/Sn ratio of Example 4 was 27, whereas that of Comparative Example 2 was 55, indicating that ‘the Sn content relative to Si’ in Example 4 was higher than that in Comparative Example 2. However, Comparative Example 2 is made of mesoporous silica having amorphous silica walls and contains almost no micropores, whereas Example 4 has a hierarchical nanoporous structure that includes a considerably high proportion of micropores. It is presumed that the tin contained inside the micropores was not able to come into contact with the 2-adamantanone, and accordingly, the catalytic performance of Example 4 is interpreted to be slightly lower than that of Comparative Example 2. Therefore, if an oxidation reaction is performed on an organic substance that can pass through micropores, it can be inferred that, contrary to the above results, the performance of the hierarchical nanoporous zeolite-based catalyst may be higher than that of the mesoporous silica-based catalyst.

### Experimental Example 7: Evaluation of Thermal Stability of Catalyst

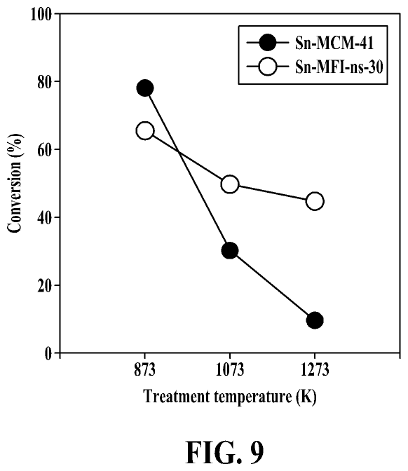

For the catalysts of Example 4 (Sn-MFI-ns-30) and Comparative Example 2 (Sn-MCM-41), the Baeyer-Villiger oxidation reaction was performed under the same reactant composition conditions as in Experimental Example 8 at temperatures of 600° C., 800° C., and 1000° C., respectively, for 20 hours. The reaction solution was then collected and analyzed by gas chromatography to measure the conversion, and the results are shown as the graph in FIG. 9.

Referring to the graph in FIG. 9, it was shown that at 600° C., the catalyst of Comparative Example 2 (Sn-MCM-41) exhibited a higher conversion than the catalyst of Example 4 (Sn-MFI-ns-30). However, as the temperature increased to 800° C. and 1000° C., it could be confirmed that the decrease in conversion according to temperature of the catalyst of Example 4 is much smaller than that of the catalyst of Comparative Example 2.

This can be seen as a result of the fact that the walls forming the mesopores of the catalyst of Comparative Example 2 are amorphous silica, whereas the zeolite forming the mesopores of the catalyst of Example 4 is crystalline, and thus has superior thermal stability compared to the amorphous silica. Therefore, it can be seen that the catalyst based on the hierarchical nanoporous zeolite carrier, such as Example 4, is superior in terms of long-term durability than the mesoporous silica-based catalyst, such as Comparative Example 2, in an actual catalytic process that is performed under a high-temperature environment for a long time.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A catalyst for a Baeyer-Villiger oxidation reaction, the catalyst comprising:
a zeolite carrier including micropores and mesopores, and having a hierarchical nanoporous structure; and
tin (Sn),
wherein an average diameter of the micropores is less than 2 nanometers (nm),
an average diameter of the mesopores is from 2 nm to 10 nm, and
a silicon (Si)/Sn ratio is from 20 to 120.

2. The catalyst of claim 1, wherein the zeolite carrier has one or more crystalline structures selected from the group consisting of MFI, BEA, MRE, and MTW.

3. The catalyst of claim 1, wherein the tin (Sn) has a size of 1 nm or less.

4. The catalyst of claim 1, wherein the catalyst for the Baeyer-Villiger oxidation reaction has a BET specific surface area from 400 m²/g to 800 m²/g, and has an external specific surface area from 200 m²/g to 600 m²/g.

5. The catalyst of claim 1, wherein the catalyst for the Baeyer-Villiger oxidation reaction has a total pore volume from 0.1 cm³/g to 1.0 cm³/g.

6. The catalyst of claim 1, wherein:
the catalyst for the Baeyer-Villiger oxidation reaction has a Lewis acid site content due to the tin (Sn) from 20 μmol/g to 150 μmol/g, and
the Lewis acid site content due to the tin (Sn) is measured by ³¹P-solid state nuclear magnetic resonance spectroscopy according to adsorption of trimethylphosphine (TMPO).

7. A method of preparing a catalyst for a Baeyer-Villiger oxidation reaction, the method comprising:
synthesizing a borosilicate zeolite having a hierarchical nanoporous structure;
synthesizing a zeolite carrier by removing boron (B) from the borosilicate zeolite; and
loading tin (Sn) metal onto the zeolite carrier.

8. The method of claim 7, wherein synthesizing of the borosilicate zeolite comprises:
stirring a solution containing a structure directing surfactant (SDS), a silicon (Si) precursor, and a boron (B) precursor;
performing hydrothermal synthesis with the solution to synthesize the borosilicate zeolite; and
calcining the synthesized borosilicate zeolite at a temperature from 450° C. to 650° C. under an oxygen (O₂) atmosphere.

9. The method of claim 8, wherein the SDS has a structure of Formula 1: 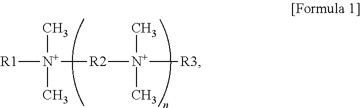
wherein R1 and R3 are each an alkyl group having 3 to 25 carbon atoms, R2 is an alkylene group having 2 to 10 carbon atoms or an arylene group having 6 to 10 carbon atoms, and n is one of the integers from 1 to 10.

10. The method of claim 7, wherein synthesizing of the zeolite carrier comprises:
mixing the borosilicate zeolite and a nitric acid solution;
heating the mixed solution to remove boron from the borosilicate zeolite; and
obtaining the zeolite carrier from which boron has been removed.

11. The method of claim 7, wherein loading of the tin (Sn) metal comprises:
dehydrating the zeolite carrier by heating under vacuum conditions;
introducing a tin (Sn) precursor into the dehydrated zeolite carrier to synthesize a tin-loaded zeolite; and
calcining the tin-loaded zeolite at a temperature from 450° C. to 650° C. under an oxygen (O₂) atmosphere.

12. The method of claim 11, wherein introducing of the tin (Sn) precursor comprises:
introducing a tin precursor into the dehydrated zeolite carrier by chemical vapor deposition (CVD).

13. The method of claim 12, wherein the tin (Sn) precursor comprises at least one of dimethyltin dichloride, trimethyltin chloride, tetramethyltin, butyltin trichloride, butyltin chloride dihydroxide, tributyltin chloride, tetrabutyltin, diphenyltin dichloride, tin dichloride, tin tetrachloride, and tin oxalate.
